(19) United States
(12) Patent Application Publication
(10) Pub. No.: US 2023/0341137 A1
(43) Pub. Date: Oct. 26, 2023

(54) DEVICE FOR HEATING AND/OR COOLING A BUILDING

(71) Applicant: GRAPHENATON TECHNOLOGIES SA, Genève (CH)

(72) Inventor: Patrick MULLER, Coppet (CH)

(21) Appl. No.: 18/245,495

(22) PCT Filed: Sep. 14, 2021
(86) PCT No.: PCT/IB2021/058350

§ 371 Date: Mar. 15, 2023

(30) Foreign Application Priority Data
Sep. 15, 2020 (CH) 01163/20

(51) Int. Cl. F24F 5/00

(52) U.S. Cl. CPC F24F 5/0089; F24F 5/0042; F24F 2221/34

(57) ABSTRACT

The invention relates to a heating and/or cooling device comprising a filmable to scatter infrared light in order to diffuse heat. The film comprises a planar heating element comprising a connector that is electrically connected to conductive tracks placed on said film and connectable to a thermostat, The film receives a conductive ink that is deposited on the film in particular by screen-printing or inkjet printing, the film being able to scatter infrared light in order to diffuse heat or cold over bodies or objects placed in proximity thereto without diffusing heat or cold into the space. The film is arranged to receive sensors and/or RFID means.

The present invention relates to a device for heating and/or cooling a building. In particular, the device comprises a film capable of diffusing infrared light and possibly comprising electronic components in order to manage the safety of people and buildings and comfort thanks to the home automation.

In order to heat a room, in particular a dwelling, it is common to have a radiator in certain rooms. Likewise, in order to cool a room, air conditioning may be installed.

WO2013179341 A1 describes a heating film comprising a planar heating element which has a pair of terminals, a pair of conductive wires soldered to the terminals and two sheets of thermoplastic polyamide film which are respectively laminated on the surfaces of the planar heating element by thermal soldering and which hold said planar heating element in a sealed state. In the heating film, the thermoplastic polyamide films can be hermetically welded by thermal soldering to the planar heating element so as to seal it.

The main problems of these solutions are complicated implementations and high power consumptions for a primary use, namely heating or cooling.

Another aim of the present invention is to propose a heating/cooling solution and management of the home automation which is faster to implement, more efficient and which does not produce any carbon emissions and which meets the requirements of construction standards, in particular the new Swiss standard RT2020 or MOPEC.

The use of the device of the present invention makes it possible to conceal and centralise the heating and air conditioning systems. This discrete solution offers high performance energy supply and non-negligible economic benefits.

The aim of this invention is to propose a solution having low investment costs, operating costs, which is reliable over time and which is easy and quick to install.

In accordance with the invention, the heating and/or cooling device comprises a film capable of diffusing infrared light to diffuse heat. The film comprises a planar heating element comprising a connector electrically connected to conductive tracks arranged on the film that can be connected to a thermostat. The film receives a conductive ink deposited on the film, in particular by screen printing or inkjet, the film being able to diffuse infrared light in order to diffuse heat or cold onto bodies or objects arranged in its proximity without diffusing heat or cold into the space. Furthermore, the film is arranged to receive sensors and/or radio-identification means.

In one embodiment, the conductive ink is deposited on the film by screen printing.

Preferably, the film receives a layer of resin in hollows forming grooves receiving the ink covered with another layer of resin.

In general, the hollows are created by an etching using a CO2 or YAG laser technique. The exceptional quality of the beam makes it possible to produce sharp and precise markings on the sheet.

In one embodiment, the ink is an ink based on carbon nanotubes, in particular graphene.

Power can be supplied to the film at several voltages, in particular 12V, 24V, 48V, 110V or 220V. The film may also be powered using solar energy. The powers also are variable.

The film is regulated by the thermostat and a smartphone. The film has an operating temperature range from 16° C. to 28° C. in heating, in particular when the heat comes from the ground.

Thanks to the present device, the ambient temperature can be lowered by ten degrees Celsius.

In zones where the temperature is very high, the film comprises a Peltier probe to lower the ambient temperature by up to forty degrees Celsius.

In one embodiment, the film incorporates sensors linked to the safety of goods and/or sensors related to the safety of people.

In another embodiment, the film comprises components allowing supervision and control of a building in which it is arranged. (Al, virtual screen).

In all the embodiments described above, the film never exceeds 0.36 mm thick, out of connectors.

In one embodiment, a reflector panel may be arranged superimposed with respect to the film, above or below or behind the device, the reflector panel having a thickness of up to 0.6 cm.

Preferably, the device is in the form of non-rollable rectangular sheets.

The device has the advantage of being able to be placed, under a covering, on the ground, on the ceiling, on a wall, behind a mirror, on a movable element such as a table, or even under a layer of bitumen. Of course, for each of these uses, the implementation of the device is adapted.

The features of the invention will appear more clearly on reading the description of several embodiments given solely by way of example, in no way limiting, with reference to the schematic figures, in which:

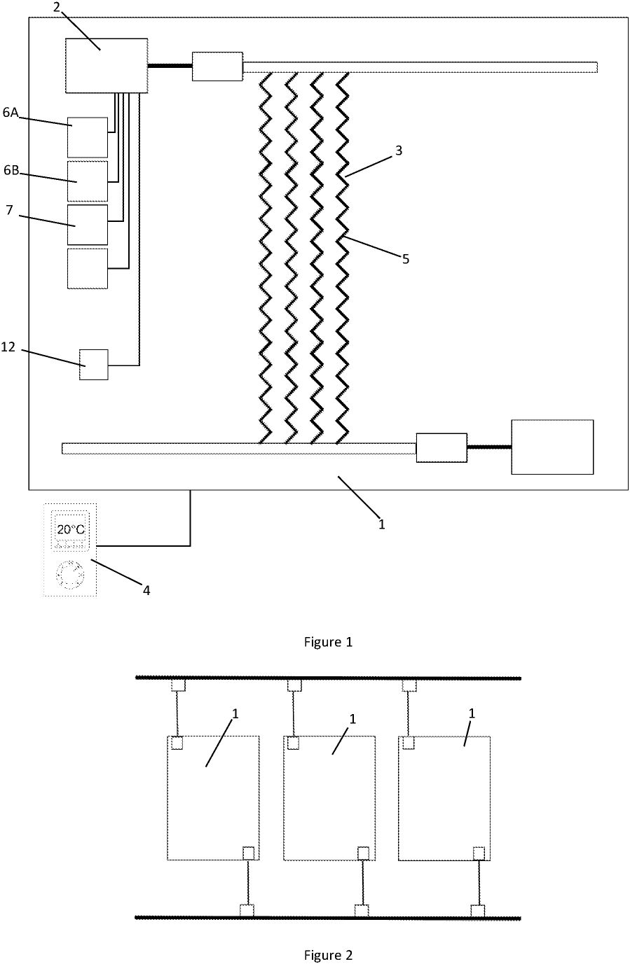

FIG. 1 shows a top view of a PET heating/cooling sheet according to the present invention;

FIG. 2 shows a top view of three sheets of FIG. 1 electrically connected together;

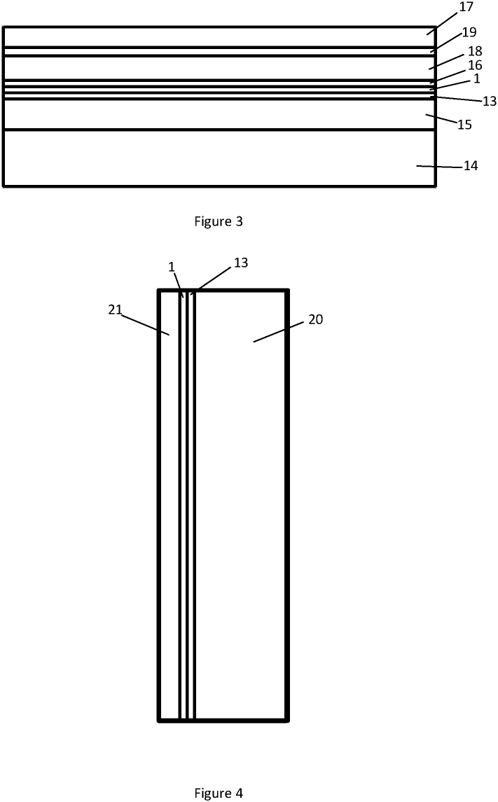

FIG. 3 shows a cross-sectional view of the device arranged on the ground;

FIG. 4 shows a sectional view of the device arranged on the wall;

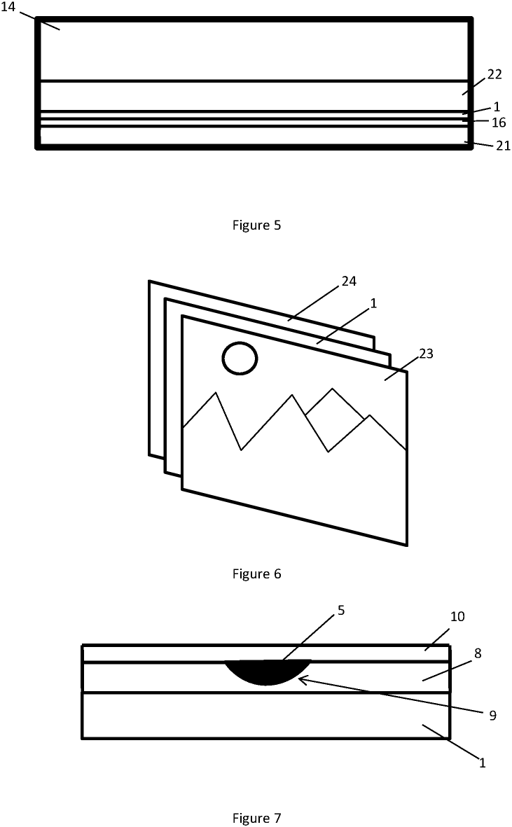

FIG. 5 shows a cross-sectional view of the device arranged on the ceiling;

FIG. 6 shows a sectional view of the device arranged on a table;

FIG. 7 represents a cross-sectional view of a film of the device in which a hollow in a resin comprises a conductive ink.

As illustrated in FIG. 1, a heating and/or cooling device comprises a film 1 capable of diffusing infrared light to diffuse heat. The film 1 comprises a planar heating element comprising a connector 2 electrically connected to conductive tracks 3 arranged on said film 1 connectable to a thermostat 4. The film 1 receives a conductive ink 5 deposited on the film by screen printing.The film 1 is capable of diffusing infrared light to diffuse heat or cold onto bodies or objects arranged in its proximity without diffusing heat or cold into the space. The film 1 is arranged to receive sensors 6 A, 6 B and radio-identification means 7 in the form of an RFID tag.

On a flexible polymer film, such as P.E.T, meeting anti-fire norms and constituting a first layer of film 1, it is applied by laser etching, a carbon nanotube-based ink 5, graphene, over 7 microns.

First, a resin 8 (see FIG. 7) is deposited on this film 1. Next, this resin is hollowed out so as to form grooves or hollows 9 (see FIG. 7) in which an ink 5 is deposited by screen printing technique.

The grooves 9 (see FIG. 7) are created by an etching by pulse laser technique over very small thicknesses. A second resin layer 10 (see FIG. 7) is deposited after the integration of the ink 5 so as to seal the sheet 1 and avoid the use of a second film to make the assembly perfectly watertight.

In this example, the thickness of the film is 360 microns but may be different depending on the use.

Each film 1 comprises connectors 2 for electrically connecting a first film 1 with a second film 1 or for integrating an electronic component 12 onto the film.

The connector is simple, robust for easy mounting and makes it possible to avoid any malfunction. The connector also meets the safety standards in force and cannot be interchangeable, in order to avoid misuse or false repair. In this example, the connections are made with conductive inks of silver nanotubes over 2 microns.

Although, in this example, the base constituting the film 1 is a PET sheet, other polymer sheets may also be considered, just like sheets comprising deposit reflective metalisation for the purpose of generating directional heating/cooling.

In the example illustrated in FIG. 2, three films 1 are electrically connected by a parallel assembly . The heating/cooling sheets each measure 0.5 mx0.5 m In other examples not illustrated, the sheets may measure 0.5mx1m or even other dimensions depending on the application.

The connections are provided in a simple and robust manner with easy of assembly, or lay the heating sheets. The connections are arranged so as to guarantee electrical safety, for applications in various environments, in particular applications in bathrooms.

In order to ensure traceability and authenticity, each sheet comprises an RFID tag 7. This RFID tag 7 is directly printed during the manufacture of the film or glued inside. This is not an additional element which would be added to the film and which would make it possible to be removed.

As illustrated in FIG. 3, a heating and/or cooling device is arranged on the floor of a building. In this embodiment, a slab 14 constituting a stable platform receives a screed 15 cast on the platform and then a heat/cold reflector panel 13 covering the slab on which the reflector panel 13 is arranged. The reflector 13 is a thin film, mainly of aluminium which makes it possible to orient the radiation in the desired direction. The latter consists of a single layer or multiple layers according to the desired use. Various layers having different functions (insulating, sound, etc.) may be associated with this reflector. It may be separated from the heating film or integral. In this example, the reflector panel has a thickness of up to 0.5 cm. The device further comprises an infrared electric heating/cooling film 1 arranged, on the reflector panel 13, for diffusing infrared rays into a space to be heated/cooled. A vapour barrier 16 is arranged on the film 1 over the entire surface of the slab, the vapour barrier exceeding at least 1 cm over the entire periphery of the slab, the vapour barrier ensuring total sealing.

In the illustrated embodiment, in particular when a tile-like covering is laid, a layer 18 comprising a mixture of sand is cast on the vapour barrier before a tiling 17 is placed on which is coated between the tiling 17 and the vapour barrier a tile adhesive 19.

In the case of use for heating, the current consumed by the heating film is 0.36A for a production of 80W/m2 of heating. Depending on the room to be heated, an 80W/m2 heating film is sufficient for floor/heating in new or very well insulated dwellings. The laying of 140W/m2 films is suggested for providing floor heating in well-insulated rooms. 220W/m2 heating films make it possible to meet heating requirements in spaces which are not very well insulated.

On the same principle as the above paragraph, it is the function of the ink which will gives the production of heat or cooling. Thus, thanks to the thermostat, it is possible to regulate the temperature of the room so as to manage heat or cold in the room.

Thanks to the same film of the present invention, it is therefore possible to manage hot and/or cold for a temperature range from 16° C. to 28° C. With regard to cold management, without additional element, it is possible to cool the ambient temperature of a room by 10° C.

For higher temperature differences, beyond 10° C., Peltier probes arranged on the film will make it possible to cool the room temperature of the room by 40° C.

As illustrated in FIG. 4, a heating and/or cooling device is arranged at the wall of a building. In this embodiment, a wall 20 constituting a stable platform receives a heat/cold reflector panel 13 covering the wall 20 on which the reflector panel 13 is arranged. The reflector is a thin film, mainly of aluminium which makes it possible to orient the radiation in the desired direction. The device further comprises a heating/cooling film 1 arranged, on the reflector panel, for diffusing infrared rays into a space to be heated/cooled. A cladding of type BA13 plaster is arranged on the film over the entire surface of the wall.

In the embodiment illustrated in FIG. 5, a heating and/or cooling device is arranged at the ceiling of a dwelling space. In this embodiment, a slab 14 constituting a stable platform receives, stacked on top of one another starting from the slab 14 forming the ceiling, an insulator 22 of fibreglass type, then the heating/cooling film 1 and then a vapour barrier and then a cladding 21 of the BA13 plaster type.

In the embodiment illustrated in FIG. 6, a heating and/or cooling device is arranged on a decorative panel. In this case, the device 1 is arranged between a painted canvas 23 and a support 24 constituting a bottom.

In order to ensure safety of the goods and people without complicating the manufacture of the device or the installation, the device of the present invention uses printable sensors thus making it possible to miniaturize them to the maximum.

Thus, for a large majority of cases, the sheets will be manufactured with sensors which will be directly integrated. However, it is also provided to position holders for the sensors that would be installed later, and in this case, the connections made with the ink can be done by resins.

For example, to locate and identify the place of a fire a GPS microchip will be included in the film support. Thus, the triggering of a smoke detector will trigger the geolocation of the film.

The device comprises an interface arranged on the film to allow an LIFI communication, that is to say based on the light, so as not to use the conventional mode of transmission of the information which is wifi and which generates electrostatic waves. Thus, information transmissions may be made inside a building at a speed 100 times greater than that of Wi-Fi.

Components for managing the home automation of the building are also arranged in the film. It is therefore provided to integrate sensors and electronic components for controlling appliances by speech, as well as components and sensors for managing the control of windows, doors, etc.

Functions related to the safety of persons are provided in particular using sensors allowing assistance and medical monitoring of a person present in the dwelling.

By virtue of various electronic components and sensors arranged on the film of the device, it is also possible to check the heart rate of a person who would follow a given sports class by virtue of a hologram.

The present device, connected to a control unit, also makes it possible to follow the energy consumption in each room, for example in a hotel.

One of the many advantages of using the present device lies in the low investment and operating costs given that there is no maintenance required. The installation of such a device is carried out quickly even in the cases of renovation.

Another advantage is that the device provides a smooth and homogeneous heat or cooling, while remaining silent, and makes it possible to reach the desired temperature rapidly, for example less than 15 minutes in order to pass from 18° C. to 25° C.

By virtue of the present invention, a user will have a better comfort and will preserve the environment, while benefiting from high efficiency and energy savings.

1. A heating and/or cooling device comprising a film capable of diffusing infrared light to diffuse heat, the film comprising a planar heating element comprising a connector electrically connected to conductive tracks arranged on said film connectable to a thermostat, characterized in that said film receives a conductive ink deposited on the film in particular by screen printing or inkjet, said film being capable of diffusing infrared light to diffuse heat or cold onto bodies or objects arranged in its proximity without diffusing heat or cold into the space, and in that said film is arranged to receive sensors and/or radio-identification means.

2. The device according to claim 1, wherein the conductive ink is deposited on the film by screen printing.

3. The device according to claim 1, in which the film receives a layer of resin in hollows forming grooves receiving ink covered with another layer of resin.

4. The device according to claim 1, in which the ink is an ink based on carbon nanotubes, in particular graphene.

5. The device according to claim 1, in which the thickness of the film is 0.36 mm.

6. The device according to claim 1, in which the film is powered from a 12V to 220V supply in particular by solar energy.

7. The device according to claim 1, in which the film is regulated by the thermostat and a smartphone.

8. The device according to claim 1, wherein the film has an operational temperature range from 16° C. to 28° C. in heating, in particular when the heat comes from the ground.

9. The device according to claim 1, arranged to lower the ambient temperature by ten degrees Celsius.

10. The device according to claim 1, comprising a Peltier probe for lowering the ambient temperature by forty degrees Celsius.

11. The device according to claim 1, in which the film incorporates sensors linked to the safety of the goods and/or sensors linked to the safety of the persons.

12. The device according to claim 1, wherein the film comprises components allowing a supervision unit and a control of a building in which it is arranged.

13. The device according to claim 1, comprising a reflector panel arranged superimposed with respect to the film, above or below or behind the device, the reflector panel having a thickness of up to 0.6 cm.

14. The device according to claim 1, in which the film is in the form of non-rollable rectangular sheets.
